(19) United States
(12) Patent Application Publication
(10) Pub. No.: US 2011/0227337 A1
(43) Pub. Date: Sep. 22, 2011

(54) FITTING FOR JACKETED TUBING

(76) Inventors: David R. Kattler, Mantua, OH (US); Gerhard H. Schlroky, Aurora, OH (US); Mark A Clason, Orwell, OH (US); Matthew J. Schiberl, Wickliffe, OH (US); Theodore J. Gausman, Concord, OH (US); William H. Glime, Chagrin Falls, OH (US); Cal R. Brown, Lyndhurst, OH (US); Gary W. Scheffel, Streetsboro, OH (US); Mark V. Gorjanc, Chesterland, OH (US)

(21) Appl. No.: 13/051,211

(22) Filed: Mar. 18, 2011

Related U.S. Application Data
(60) Provisional application No. 61/315,202, filed on Mar. 18, 2010.

(51) Int. Cl. F16L 19/00; F16B 37/00

(52) U.S. Cl. 285/351; 411/427

(57) ABSTRACT

A conduit fitting includes first and second fitting components that can be joined, and at least one conduit gripping device that can grip and seal against an unjacketed portion of a metal conduit when the first and second fitting components are pulled up on the metal conduit. The conduit fitting further includes a sealing element and a seal engaging member that can be joined with at least one of the metal conduit, the first fitting component, and the second fitting component to compress the sealing element against a jacketed portion of the metal conduit.

### CROSS-REFERENCE TO RELATED APPLICATION

The present application claims priority from U.S. Provisional Application Ser. No. 61/315,202, entitled “FITTING FOR JACKETED TUBING,” filed on Mar. 18, 2010, the entire disclosure of which is fully incorporated herein by reference.

### TECHNICAL FIELD OF THE INVENTIONS

The present disclosure relates to fittings for making mechanically attached connections between a conduit and another fluid component, for containing liquid or gas fluids. More particularly, the disclosure relates to fittings for jacketed conduits.

### SUMMARY OF THE DISCLOSURE

In accordance with an embodiment of one or more of the inventions presented in this disclosure, a fitting for a jacketed conduit includes a first fitting component (for example, a fitting body or fitting nut), a second fitting component (for example, a fitting body or fitting nut), at least one conduit gripping device, and a jacket sealing device for providing a moisture-tight seal against the jacketed conduit. In one embodiment, the protective cover or sheath of the jacketed conduit is removed or otherwise absent from a portion of the tubing so that the conduit gripping device can grip and seal against the metal tubing. The jacket sealing device forms a moisture-tight seal against a portion of the protective cover or sheath, and may additionally foim a moisture-tight seal against a sealing surface of one of the first and second fitting components. In a more specific embodiment, the fitting assembly may include a first fitting component, a second fitting component joinable to the first fitting component, one or more conduit gripping devices, a sealing element and a seal engaging member that is joinable with at least one of the metal conduit, the first fitting component, and the second fitting component to compress the sealing element against a jacketed portion of the metal conduit. The sealing element may form a moisture-tight seal with the jacketed portion of the metal conduit. The sealing element may additionally form a moisture-tight seal against a sealing surface of the fitting (for example, against an extension of the fitting nut).

In one such exemplary embodiment, the seal engaging member includes a fastening member, such as a seal nut, that is threadably assembled with the fitting (for example, with a threaded extension of a fitting nut) for compression of the sealing element between a drive surface of the seal nut and a sealing surface of the fitting (for example, a sealing surface of the fitting nut). Additional features may include a sleeve that extends from the fastening member to cover the hex flats of the fitting nut, a sealing element adapted to provide a positive indication of proper tightening of the fastening member, and a sealing element formed to be retained with a fastening member as a self-contained subassembly.

In another embodiment, a fitting is provided with a jacket sealing device that includes an O-ring sealing element that is compressed between an end portion of the fitting (for example, the fitting nut) and a seal engaging member to seal against a jacket end portion of a jacketed tubing when the seal engaging member is assembled with the fitting.

In another embodiment, a fitting is provided with a jacket sealing device that includes a seal engaging member that is slid or pushed against an end face of the fitting (for example, on a fitting nut) to compress a sealing element against the fitting and into sealing engagement with a jacketed portion of a jacketed conduit.

In another embodiment, a fitting is provided with a jacket sealing device that includes a sleeve-type sealing element secured over a jacket end portion at a first end of the sleeve and over a portion of the fitting (for example, over a portion of a fitting nut) at a second end of the sleeve. In one such embodiment, a clamp-type seal engaging member is secured around the sleeve to compress or constrict the sleeve to maintain sealing engagement with the jacket end portion and fitting nut. In another embodiment, a sealing sleeve is sized to provide a sealing compression grip on the jacket end portion and on the fitting nut without utilizing a seal engaging member.

Other exemplary jacket sealing arrangements that may not require a separate seal engaging member include an elastomeric cover that slides on the conduit into sealing engagement with an end face of a fitting nut, a grommet that is wedged or pushed against an inner peripheral recess of a fitting nut, an O-ring seal that is squeezed between a jacket end portion of a conduit and a fitting nut end face, an O-ring that is compressed within an internal recess of a fitting nut to seal against a jacket end portion, and a sealant that is injected through an access port in a fitting nut into an internal recess of the fitting nut to seal against a jacket end portion.

According to another aspect of one or more of the inventions, a fitting is provided with a jacket sealing device that provides a seal between a jacket end portion and a fitting nut without a separate sealing element. In one such embodiment, the jacket end portion is deformed or otherwise manipulated to function as a sealing element. For example, a jacket end portion may be rolled or expanded and axially compressed between a fitting nut and a seal engaging member assembled with the fitting nut. As another example, a portion of a fitting nut may be inserted underneath a jacket end portion, and the jacket end portion may be radially compressed between the fitting nut and a seal engaging member assembled with the fitting nut.

In another embodiment, a fitting nut is provided with a jacket sealing structure configured to grip and seal against a jacketed portion of a conduit when the fitting is installed on the conduit. In one example, a seal engaging member is assembled with a fitting nut to radially compress a jacket sealing structure of the fitting nut into sealing engagement with the jacket end portion. In another example, a fitting nut is provided with a radially inwardly biased jacket sealing structure that is configured to seal against a jacket end portion upon installation of the fitting with the tubing, without the assembly of a separate seal engaging member.

In accordance with another embodiment of one or more of the inventions presented in this disclosure, a fitting for jacketed tubing includes a body-nut sealing arrangement to provide a moisture-tight seal over a threaded connection between a fitting body and a fitting nut. In one such embodiment, a sealant is applied to the mating threads of the fitting body and fitting nut. In another embodiment, a seal is provided between opposed surfaces of the fitting body and fitting nut, with the seal being compressed between the opposed surfaces to effect a seal around the mating threads when the fitting is pulled up. In still another embodiment, a jacket sealing device is configured to fully surround the assembled fitting connection of the fitting body, fitting nut, and conduit end to provide a moisture-tight seal over both the body-nut connection and the unjacketed tubing outboard of the mechanical seal between the fitting and the conduit end.

### BRIEF DESCRIPTION OF THE DRAWING

The drawings illustrate various embodiments of fitting assemblies, wherein:

FIG. 1 illustrates an embodiment of a fitting assembly, shown in longitudinal cross-section, that provides both a mechanical connection to a metal conduit end portion, and a moisture-tight seal against a protective covering of the conduit;

FIG. 2 illustrates an embodiment of a fitting assembly, shown in longitudinal cross-section, utilizing a jacket sealing device including a nut and grommet;

FIG. 3 illustrates another embodiment of a fitting assembly, shown in longitudinal cross-section, utilizing a jacket sealing device including a nut and grommet, with the upper half of the cross-sectional view showing the jacket sealing nut in the loosely assembled condition, and the lower half of the cross-sectional view showing the jacket sealing nut in the jacket sealing condition;

FIG. 4 illustrates still another embodiment of a fitting assembly, shown in longitudinal cross-section, utilizing a jacket sealing device including a nut and grommet;

FIG. 5 illustrates an embodiment of a fitting assembly, shown in longitudinal cross-section, utilizing a jacket sealing device including a nut and O-ring seal;

FIG. 6 illustrates an embodiment of a fitting assembly, shown in longitudinal cross-section, utilizing a jacket sealing device including a male-threaded nut and O-ring seal;

FIG. 7 illustrates an embodiment of a fitting assembly, shown in longitudinal cross-section, utilizing a jacket sealing device including a spring washer and O-ring seal;

FIG. 8 illustrates an embodiment of a fitting assembly, shown in longitudinal cross-section, utilizing a jacket sealing device including a hollow cap and sealant;

FIG. 9 illustrates an embodiment of a fitting assembly, shown in longitudinal cross-section, utilizing a jacket sealing device including a push-to-connect seal;

FIG. 10 illustrates an embodiment of a fitting assembly, shown in longitudinal cross-section, utilizing a jacket sealing device including an elastomeric sleeve and clamp;

FIG. 11 illustrates an embodiment of a fitting assembly, shown in longitudinal cross-section, utilizing a jacket sealing device including an elastomeric sleeve;

FIG. 12 illustrates an embodiment of a fitting assembly, shown in longitudinal cross-section, utilizing a jacket sealing device including a roll-able elastomeric sleeve with the upper half of the cross-sectional view showing the sleeve in the rolled condition, and the lower half of the cross-sectional view showing the sleeve in the unrolled condition;

FIG. 13 illustrates an embodiment of a fitting assembly, shown in longitudinal cross-section, utilizing a jacket sealing device including an elastomeric gland;

FIG. 14 illustrates an embodiment of a fitting assembly, shown in longitudinal cross-section, utilizing a jacket sealing device including an elastomeric gland with a nut retaining sleeve;

FIG. 15 illustrates an embodiment of a fitting assembly, shown in longitudinal cross-section, utilizing a jacket sealing device including a grommet securable against a fitting nut;

FIG. 16 illustrates an embodiment of a fitting assembly, shown in longitudinal cross-section, utilizing a jacket sealing device including an O-ring seal axially squeezed between a jacket end portion and a fitting nut;

FIG. 17 illustrates an embodiment of a fitting assembly, shown in longitudinal cross-section, utilizing a jacket sealing device including an O-ring seal radially squeezed between a jacket end portion and a fitting nut, with the upper half of the cross-sectional view showing the fitting nut in the loosely assembled condition, and the lower half of the cross-sectional view showing the fitting nut in the jacket sealing condition;

FIG. 18 illustrates an embodiment of a fitting assembly, shown in longitudinal cross-section, utilizing a jacket sealing device including a fitting nut with a sealant retaining recess;

FIG. 19 illustrates an embodiment of a fitting assembly, shown in longitudinal cross-section, utilizing a jacket sealing device including a fitting nut and seal nut configured to axially squeeze a rolled up end portion of a tubing jacket;

FIG. 19A illustrates an embodiment of a tool configured to roll an end portion of a tubing jacket;

FIG. 20 illustrates an embodiment of a fitting assembly, shown in longitudinal cross-section, utilizing a jacket sealing device including a fitting nut and seal nut configured to expand and radially squeeze an end portion of a tubing jacket;

FIG. 21 illustrates an embodiment of a fitting assembly, shown in longitudinal cross-section, utilizing a jacket sealing device including a fitting nut and seal nut configured to expand and radially squeeze an end portion of a tubing jacket;

FIG. 22 illustrates an embodiment of a fitting assembly, shown in longitudinal cross-section, utilizing a jacket sealing device including a fitting nut and seal nut configured to seal against a bulged end portion of a tubing jacket;

FIG. 23 illustrates an embodiment of a fitting assembly, shown in longitudinal cross-section, utilizing a jacket sealing device including a fitting nut with a deformable collar and a seal nut that radially compresses the deformable collar into sealing engagement with an end portion of a tubing jacket, with the upper half of the cross-sectional view showing the jacket sealing nut in the loosely assembled condition, and the lower half of the cross-sectional view showing the jacket sealing nut in the jacket sealing condition;

FIG. 24 illustrates an embodiment of a fitting assembly, shown in longitudinal cross-section, utilizing a jacket sealing device including a fitting nut with a jacket engaging collar;

FIG. 25 illustrates an embodiment of a fitting assembly, shown in longitudinal cross-section, utilizing a gasket seal between opposed surfaces of the fitting body and nut; and

FIG. 26 illustrates an embodiment of a fitting assembly, shown in longitudinal cross-section, utilizing a jacket sealing device including a fitting encapsulating nut.

### DESCRIPTION OF THE EXEMPLARY EMBODIMENTS

Although the exemplary embodiments herein are presented in the context of a stainless steel tube fitting, the inventions herein are not limited to such applications, and will find use with many different conduits such as tube and pipe as well as different materials other than 316 stainless steel, for example, copper, including different metals for either the conduit, the gripping devices or the fitting components or any combination thereof. The inventions may also be used for liquid or gas fluid systems. While the inventions herein are illustrated with respect to particular designs of the jacket sealing devices, conduit gripping devices and fitting components, the inventions are not limited to use with such designs, and will find application in many different fitting designs that use one or more conduit gripping devices. In the drawings, various gaps and spaces between parts (for example, gaps between the ferrules and the conduit in a finger-tight position) may be somewhat exaggerated for clarity or due to scale of the drawings. Although we describe the exemplary embodiments in terms of “jacketed tubing,” the inventions are not limited to tubing but may be used with any conduit including pipe. Therefore the word “tubing” herein is used only as an example of one type of conduit with which the inventions may be utilized. The inventions also are not limited to conduits that may fall within the common understanding of the terms “jacket” and “jacketed,” rather the terms jacket and jacketed are used for convenience to refer to any protective sheath, cover, treatment or coating, and to any metal conduit having a protective sheath, cover, treatment or coating about its exterior surface, especially protective layer or layers for anticorrosion protection.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Moreover, while various aspects, features and concepts may be expressly identified herein as being inventive or fowling part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

With reference to the drawings, several embodiments of the inventions are presented. All references herein to “radial” and “axial” are referenced to the X axis, as shown in the drawings, except as may otherwise be noted. Also, all references herein to angles are referenced to the X axis except as may otherwise be noted.

External corrosion of metal tubing can negatively impact the performance of tubing installations. Although corrosion resistant tubing may be used, such tubing is usually of higher cost which can be a significant factor for systems that use long and extensive tubing runs. As a lower cost alternative to corrosion resistant tubing, a protective polymer or elastomer layer, commonly known as a jacket, is applied over standard, less expensive tubing. The jacket may be formed onto the tubing such as by extrusion or receive the tubing such as with a slip fit, shrink-fit, spray-on, dip-coat, etc., to name a few examples. The protective jacket, which is also referred to herein as a protective layer, coating, cover or sheath, may be made of any suitable material, with polyvinylchloride (PVC) and thermoplastic urethane (TPU) being in common use today, but other materials may be used including but not limited to PFA and PTFE. The jacket is used to provide a water proof or moisture proof barrier to inhibit corrosion, for example crevice corrosion, that might otherwise occur due to environmental exposure, particularly marine environments, for example. Jacketed tubing may be used with mechanical connections such as ferrule type tube fittings, but in order to make the mechanical connection, the jacket must be cut away, pulled back, or otherwise absent from the tube end or other portion where the mechanical connection is to be made in order for the ferrules (or other such conduit gripping devices) to properly grip and seal the tubing. In the past, the exposure of the end portion of the tubing for fitting make-up further necessitated adding a heat shrink material or an adhesive material such as silicon tape to the exposed tube end after the mechanical connection was completed. The use of shrink wrap material or self adhesive tape have numerous disadvantages, particularly for post-installation activities. The present disclosure is directed to better designs and methods for protecting the exposed tubing where the protective jacket has been removed, for example, to allow a mechanical connection to be made to the tubing without compromising the corrosion resistance of the jacketed tubing.

The present disclosure contemplates fitting assemblies that provide both a mechanical connection to an unjacketed or exposed portion of a metal tube end, and a moisture-tight seal against a protective covering or jacket of the tubing to seal the unjacketed portion of the tubing from external moisture and other contaminants. According to an aspect of the present disclosure, a fitting assembly may include a tube fitting component and a jacket sealing device that seals against an outer surface of the jacket when the jacket sealing device is assembled with the tube fitting component. In one embodiment, a jacket sealing device is configured to be assembled with a fitting nut to provide a moisture-tight seal between the fitting nut, the jacket sealing device, and the tubing jacket.

While the inventive aspects of the present disclosure may be utilized with a variety of fittings, in one embodiment, a two-ferrule compression tube fitting is provided with a jacket sealing device for preventing exposure to moisture of an uncovered or unjacketed portion of a tube (which may, but need not, be the endmost portion of the tube) with which the fitting is assembled. In the exemplary embodiment of the drawing, a fitting assembly 10 is provided for jacketed tubing J. The jacketed tubing J includes a metal tube 1 and a protective coating or sheath 2, also commonly referred to as a jacket. The jacket 2 may be made of any suitable material including but not limited to PVC and TPU, and may be applied to the metal tube 1 by any suitable process as is well known in the art. Jacketed tubing is commercially available from different tubing suppliers. The metal tube may be provided in any metal that is convenient for a particular installation, including but not limited to stainless steel and copper.

The fitting assembly 10 may include a first coupling or fitting component 3 having a first end or end connection 4 that is joinable to a second coupling or fitting component 5. These parts are commonly known in the art as a nut and body respectively, wherein the body 5 receives a tube end portion, and the nut end connection 4 may be joined to the body 5 during make up of the fitting. Although we use the common terms of body and nut herein as a convenience, those skilled in the art will appreciate that the inventions are not limited to applications wherein such terminology may be used to describe the parts. The body 5 may be a stand-alone component as illustrated or may be integral with or integrated or assembled into another component or assembly such as, for example, a valve, a tank or other flow device or fluid containment device. The body 5 may have many different configurations, for example, a union, a tee, an elbow and so on to name a few that are well known in the art. Although the body 5 and the nut end connection 4 are illustrated as being threadably joined together by a threaded connection T, threaded connections are not required in all uses. For example, some fittings have parts that are clamped together to give one example. Fittings are also commonly referred to in the art as male fittings or female fittings, with the distinction being that for a male fitting the body includes an externally male threaded portion and the nut includes an internally female threaded portion. For a female fitting, the nut includes an externally male threaded portion and the body includes an internally female threaded portion. The exemplary embodiments herein illustrate a male fitting assembly embodiment, for example, but the inventions may be conveniently adapted for use with a female fitting assembly.

The mechanical body-nut connection 40 of the fitting 10 may be used to form a fluid-tight connection between an end portion 12 of the tubing 1 and the body 5 using one or more conduit gripping devices 6, which in the exemplary embodiments herein may be realized in the form of one or more ferrules 6, including in this embodiment a front ferrule 61 and a back ferrule 62. However, conduit gripping devices other than those that may be understood in the art as ‘ferrules’ may also be used with the inventions herein. The tubing 1 typically bottoms against a radial shoulder 13 that is part of the body 5, and is well known. The body 5 includes a camming surface 20 that engages the front portion of the front conduit gripping device or ferrule 61. The front ferrule 61 includes a camming surface 26 at its back or outboard end that engages a front portion of a second or back conduit gripping device or ferrule 62. The back ferrule 62 includes a driven surface 32 that engages a drive surface 34 of the female nut 4. The front and back ferrules include cylindrical interior walls 37, 39 that are closely received over the outer surface 38 of the tubing 1 and within a cavity 7 formed by the nut 4 and body 5. Although the exemplary embodiments herein illustrate fitting assemblies that use a conduit gripping device or ferrule set having two conduit gripping devices or ferrules, the inventions will readily find application to fittings that may use only a single conduit gripping device, as well as fittings that may use ferrule sets having more than two conduit gripping devices, or additional parts other than just ferrules or conduit gripping devices, for example, additional seals.

The body 5, end connection portion 4 of the nut 3 and the ferrules 6 thus form a mechanical connection 40 that is well known and commonly used for as a flareless tube end connection to provide a grip and seal against the outer metal surface of the tubing 1. In order for the mechanical connection 40 to work properly, the protective jacket 2 is removed or otherwise absent from a portion of the tubing 1 that will be used to form the mechanical connection. Thus, the jacket 2 will extend to an end 42, leaving an exposed portion 38 of the tubing 1. The jacket 2 may be assembled or fitted with the tubing 1 so as to terminate at the end 42. Alternatively, an endmost portion of the jacket 2 initially covering the exposed portion 38 may be removed by any convenient technique including cutting or peeling/rolling back the jacket 2.

It is important to note that the exemplary geometric shapes, configurations and designs of the fitting coupling components 4, 5 and the conduit gripping devices 61, 62 are a matter of design choice and will depend in great measure on the materials used, and the design and performance criteria expected of the fitting. Many different coupling components and conduit gripping device designs are known in the art and may be designed in the future, including, for example, flared tubing connections and permanent fitting connections (e.g., Phasetite®).

The term “complete pull-up” and derivative terms as used herein refers to joining the fitting components 4 and 5 together so as to cause the one or more conduit gripping devices 6 to deform, usually but not necessarily plastically deform, to create a fluid-tight seal and grip of the mechanical connection 40 on the tubing 1. A “partial pull-up” and derivative terms as used herein refers to a partial but sufficient tightening of the male and female fitting components together so as to cause the conduit gripping device or devices to deform so as to be radially compressed against and thus attached to the tubing, but not necessarily having created a fluid-tight connection or the required grip that is achieved after a complete pull-up. The term “partial pull-up” thus may also be understood to include what is often referred to in the art as pre-swaging wherein a swaging tool is used to deform the ferrules onto the tubing sufficiently so that the ferrules and the nut are retained on the tubing prior to being mated with the second fitting component to form a fitting assembly. A finger tight position or condition refers to the fitting components and conduit gripping devices being loosely assembled onto the tubing but without any significant tightening of the male and female fitting components together, usually typified by the conduit gripping device or devices not undergoing plastic deformation. The drawings herein show the mechanical connection 40 in a finger-tight condition prior to final tightening and pull-up.

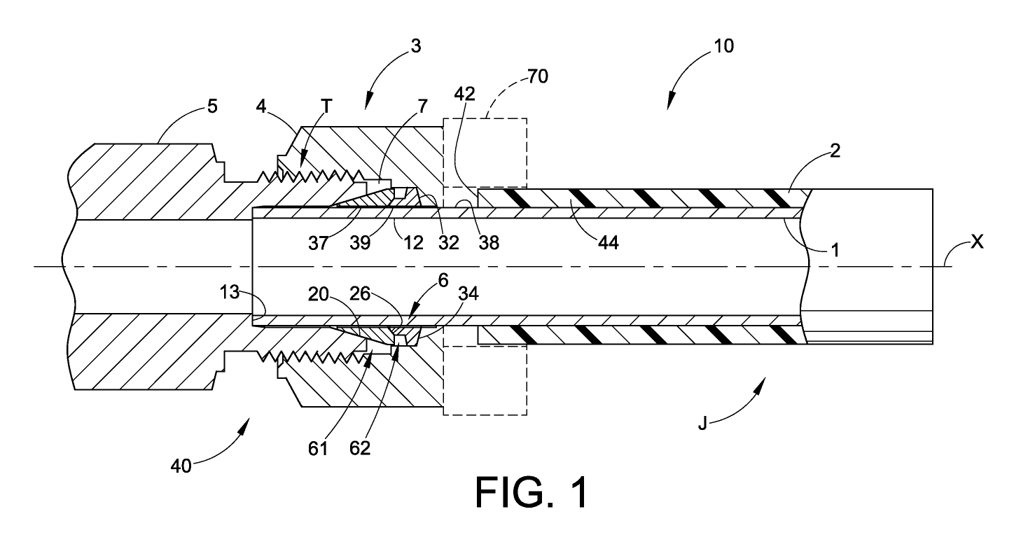

FIG. 1 illustrates the mechanical connection 40 in a finger-tight position, meaning that the various parts including the fitting body 5, fitting nut 3, and ferrules 61, 62 have been manually assembled onto the tubing 1 but are loosely assembled or slightly tightened or snugged up by manually joining the nut 3 and body 5 together. Fittings are commonly pulled-up to a complete pulled-up position by counting complete and partial turns of the nut 3 relative to the body 5 from the finger-tight position. The present inventions, however, may be used with fitting designs that alternatively may be pulled-up by torque. Examples of fitting designs that may be pulled-up by torque are described in U.S. ______, the entire disclosures of which are incorporated herein by reference.

In order to effect complete grip and seal, the nut end connection 4 and body 5 are tightened together—commonly known in the art as pull-up or pulling up the fitting and derivative terms—such that the back ferrule 62 and front ferrule 61 axially advance against their respective camming surfaces 26 and 20. This causes a radially inward compression of the ferrules against the outer metal surface of the tubing 1 to effect grip and seal. In the exemplary fitting assembly herein, grip is primarily achieved with the back ferrule, with the front ferrule primarily providing a fluid-tight seal. However, in some designs the front ferrule may also grip the tubing and the back ferrule may also provide a fluid-tight seal. Thus, the term “conduit gripping device” may include two distinct functions, namely grip and seal, whether or not a specific conduit gripping device performs one or both of those functions. The present inventions may alternatively be used with single conduit gripping device style fittings in which a single conduit gripping device performs both the grip and seal functions, and still further alternatively may be used with fittings that use more than two conduit gripping and sealing devices. Although not limiting the scope of the present inventions, the exemplary fitting design illustrated herein is of a type well known and commercially available from Swagelok Company, Solon, Ohio. Examples of such fittings that may be provided with one or more of the inventive features of the present disclosure are described in a number of issued and pending patent applications, including U.S. Pat. Nos. 5,882,050 and 6,629,708, which describe a two-ferrule fitting with a rear ferrule having a geometry designed to reduce galling, localized loading, and torque forces, the entire disclosures of which are fully incorporated herein by reference.

To provide a moisture-tight seal over the exposed portion 38 of the tubing 1, the fitting 10 of FIG. 1 includes a jacket sealing device, represented schematically at 70, that effects a seal between the nut 3 and the jacket 2. As described and shown in the several exemplary embodiments described herein, some or all of the jacket sealing device 70 may be integral with the nut 3 and/or may include one or more components configured to assemble with or seal against the nut 3. In some embodiments, the jacket sealing device 70 may include a single component that provides both mechanical attachment to the nut 3 and sealing engagement with the nut and jacket. In other embodiments, the jacket sealing device 70 may include a seal engaging member (e.g., a fastening member, such as a nut or clamp) and a separate sealing element (e.g., an O-ring, gasket, or grommet). The sealing element may include a first portion that seals against the nut 3 and a second portion that seals against the jacket 2 to complete a seal over the exposed or unjacketed portion 38 of the tubing 1.

In an exemplary method, a mechanical connection for jacketed tubing is provided, with the method including the steps of attaching a fitting to an unjacketed portion of a metal tube by using a ferrule-type fitting assembly to provide grip and seal against the unjacketed portion of the tube, and securing a sealing member in sealing engagement with the fitting (for example, with the nut) and with a jacketed portion of the tube by joining a seal engaging member with at least one of the fitting nut, fitting body, and metal tube.

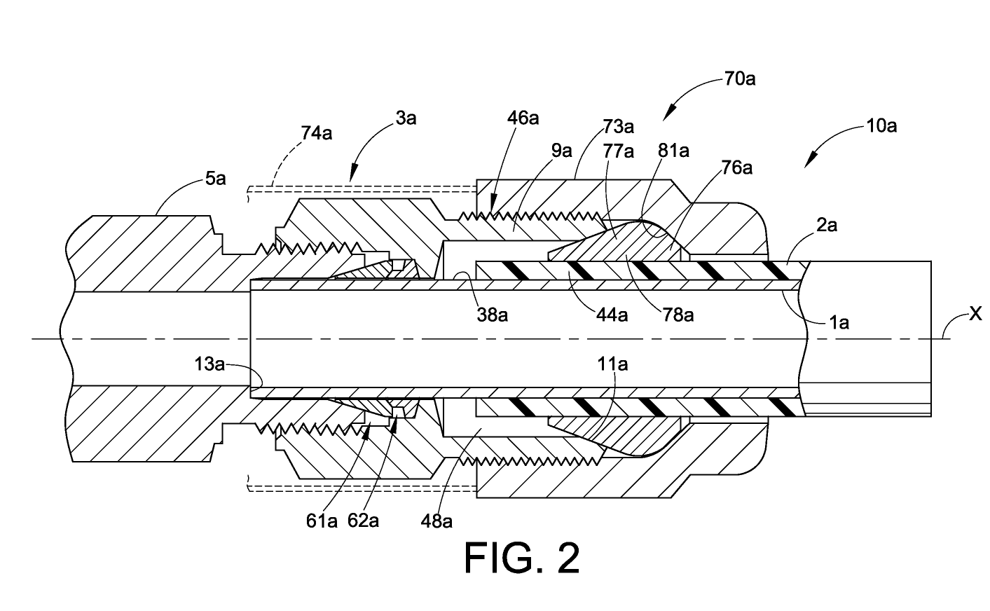

FIG. 2 illustrates an exemplary fitting 10a provided with a jacket sealing device 70a including a seal engaging member 73a for assembly with the fitting nut 3a, and a sealing element 76a having a first portion 77a that seals against the fitting nut 3a and a second portion 78a that seals against an end portion 44a of the jacket 2a. While the fitting nut 3a and fastening member 73a may utilize any suitable mechanical connection, the fitting nut 3a of the illustrated embodiment includes a generally cylindrical extension 9a that is sized to extend over an end portion 44a of the jacket 2a when the tubing 1a has been fully inserted and seated against the body shoulder 13a. The extension 9a mates with female threads of the fastening member 73a, formed as a second nut (or seal nut) or cap, for example, by a threaded connection 46a. The exemplary sealing element 76a is captured in a cavity defined between the jacket portion 44a and an interior wall of the seal nut 73a, and is formed as an elastomeric sleeve or grommet. The seal nut 73a includes an interior wall or drive surface 81a that compresses the sealing element 76a against the outer surface of the jacket 2a when the seal nut 73a is tightened onto the nut extension 9a. The nut extension 9a also may include a tapered or other profile surface 11a that retains the sealing element 76a in the cavity 48a as the sealing element 76a is compressed against the jacket 2a. In this manner, the sealing element 76a forms a fluid-tight seal with the jacket 2a, thus protecting the exposed portion 38a of the tubing 1a, including the portion that is outboard of the ferrules 61a, 62a. Further, the sealing element 76a may additionally form a fluid-tight or moisture tight seal with the tapered nut sealing surface 11a, to further prevent leakage past the threads of the seal nut 73a. Whether the seal formed against the jacket is considered a moisture resistant seal or a fluid-tight seal will depend on the intended application and resistance to fluid and moisture needed, particularly at elevated pressures. In one example, the sealing element 76a may provide a leak-tight seal to 15 bar.

The fitting assembly 10a thus may utilize known or later developed mechanical connections of the flareless tube end variety using one or more conduit gripping devices or ferrules, with a nut that is modified to include a second end that can be mated to a second nut (or seal nut) or cap. While the seal nut 73a may be tightened before the mechanical connection is pulled-up, in some applications, it may be desirable to pull up the mechanical connection before tightening the seal nut, to minimize twisting of the tubing jacket 2a on the tube 1a by the seal nut 73a during pull up.

When disassembling the exemplary fitting 10a, it may be desirable to loosen the seal engaging member or seal nut 73a before loosening the fitting nut 3a, such that the jacket end portion 44a is not twisted on the tubing 1a as the fitting nut 3a is loosened. To impede loosening of the fitting nut 3a while the seal nut 73a remains tightened, the seal nut 73a may be provided with a sleeve or extension, shown schematically at 74a, which covers the hex flats of the fitting nut 3a when the seal nut 73a is tightened. This sleeve 74a may be integral to the seal nut 73a or assembled with the nut (e.g., a plastic sheath). In one embodiment, the sleeve 74a may be removable and/or disposable, such that the sleeve may be removed to make intentional adjustments to the fitting nut 3a and/or the seal nut 73a (for example, allowing an installer to apply one wrench to the fitting nut flats and a second wrench to the seal nut flats to tighten or loosen the seal nut 73a. The sleeve 74a may be provided with text or other indicia notifying the installer that the seal nut 73a should be loosened before loosening the fitting nut 3a.

The sealing element may be provided in many different suitable geometries and materials. In one embodiment, a fitting nut extension and seal nut may utilize the designs and dimensions of one or more electrical cable gland assemblies known in the art, in combination with a cable gland grommet or a seal member resembling a cable gland grommet utilized as a sealing element between a jacket end portion and the fitting nut. In the embodiment of FIG. 2, the fitting nut extension 9a and seal nut 73a may be provided with thread and sealing geometries described in German patent publication DE 10 2004 061 488 A1, and the sealing element 76a may be provided with a geometry consistent with grommets described in German patent publication DE 20 2005 005 320 Ul, the entire disclosures of both of which are incorporated herein by reference. The sealing element may be provided in a suitable elastomeric material, such as, for example, any one or more of thermoplastic elastomers, theiinosets, Santoprene®, Perbunan®, Tefabloc®, silicone, NBR, nitrile rubber, and neoprene. The shape, size, geometry and material of the sealing element 76a need not be as shown in the drawing, and may be selected to provide the desired seal function to protect the exposed metal portion of the tubing 1a that is outboard of the ferrules 61a, 62a.

While thread engagement between the seal nut 73a and the fitting nut 3a may be sufficient to maintain a sufficiently tight, jacket sealing condition for the jacket sealing device 70a, in other embodiments, a seal nut may be secured in the jacket sealing condition by one or more nut-locking features, including, for example, a counter nut, lock washer, sealant, or other such configuration, for example, to prevent loosening of the seal nut due to system vibrations, thermal cycling, or other such conditions.

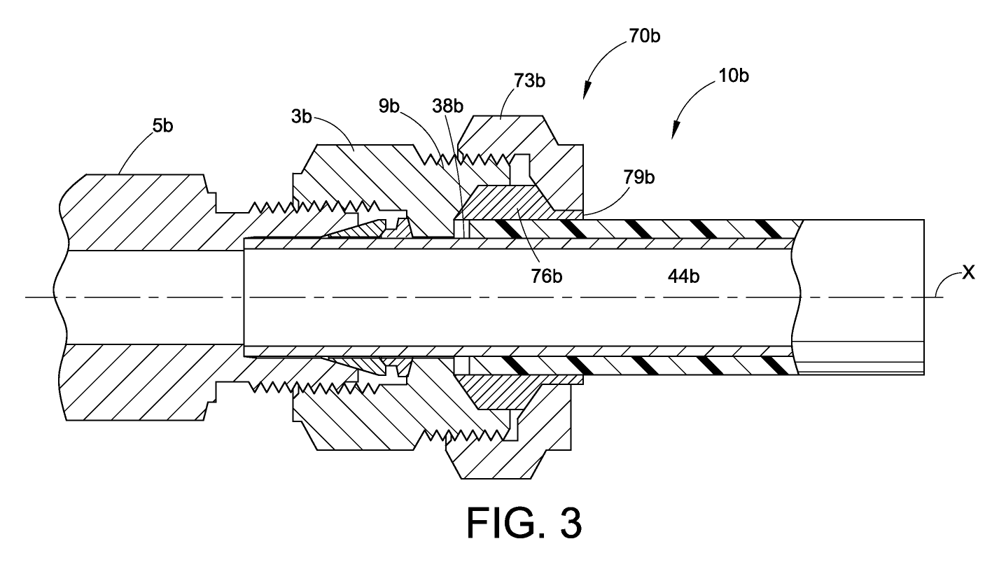

In another embodiment, a grommet seal may be configured to provide a positive indication of proper installation of the seal engaging member (e.g., proper tightening of a seal nut). In the exemplary embodiment of FIG. 3, the fitting 10b includes an elastomeric sealing member 76b provided with a tail portion 79b that extrudes outward of the seal nut 73b to provide a visual indication that the seal nut 73b has been sufficiently tightened to provide a moisture-tight seal over the exposed portion 38b, as shown in the bottom half of FIG. 3.

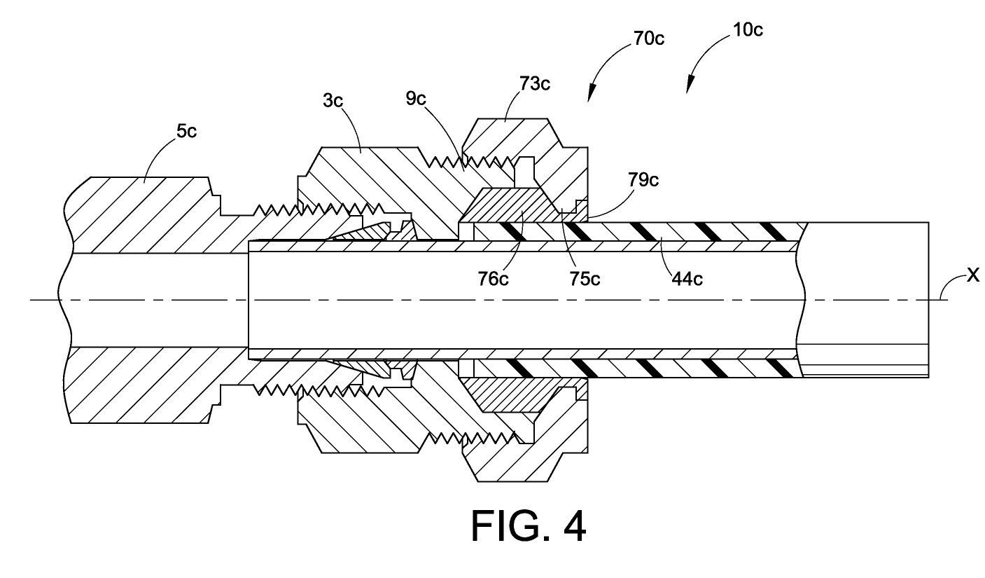

In still another embodiment, a grommet sealing element may be formed to be retained with a seal engaging member as a self-contained subassembly, to ensure the sealing member is present and properly oriented during fitting assembly. In the exemplary embodiment of FIG. 4, a fitting 10c includes a sealing member 76c having a flanged end 79c configured to interlock with an internal ridge 75c in the seal nut 73c, thereby retaining the sealing member 76c within the seal nut 73c.

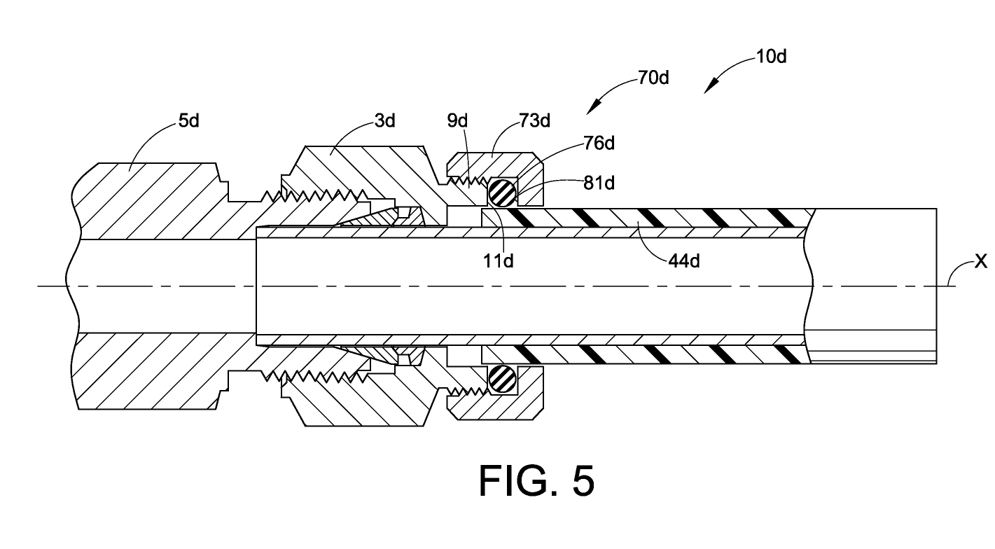

In other embodiments, an O-ring seal may be compressed between a fitting nut and a seal engaging member (e.g., a second nut or seal nut) to seal against the fitting nut and the jacket end portion. FIG. 5 illustrates an exemplary fitting 10d that includes a second nut or seal nut 73d for assembly with a threaded extension 9d of a fitting nut 3d, and an O-ring seal 76d that is axially compressed between a sealing surface 11d of the fitting nut 3d and a drive surface 81d of the seal nut 73d to seal against the jacket end portion 44d. One or both of the sealing surface 11d and drive surface 81d may be tapered to facilitate radial inward compression of the O-ring seal 76d when the seal nut 73d is tightened with the fitting nut 3d.

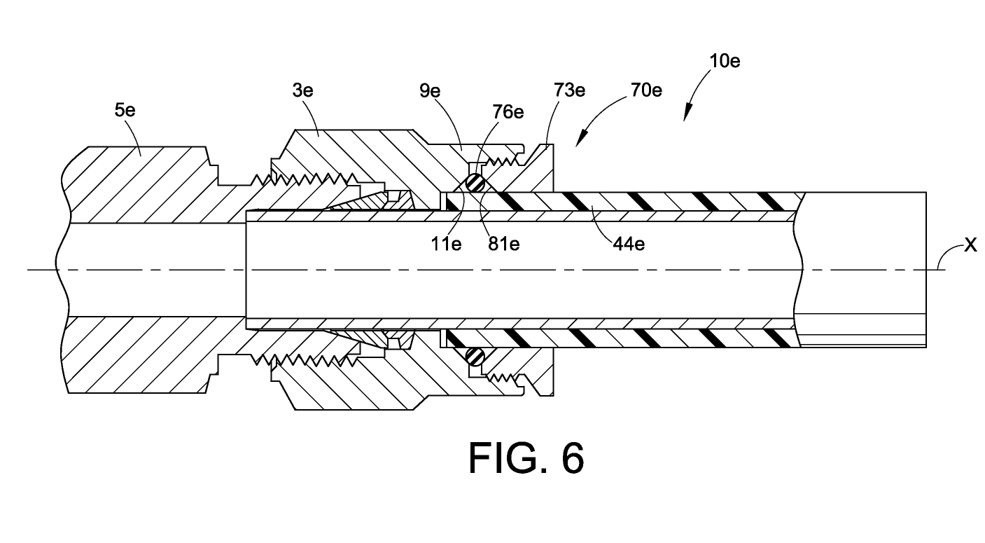

FIG. 6 illustrates an exemplary fitting 10e that includes a male threaded second nut or seal nut 73e for assembly with a female threaded extension 9e of the fitting nut 3e, and an O-ring seal 76e that is axially compressed between a sealing surface 11e of the fitting nut 3e and a drive surface 81e of the seal nut 73e to seal against the jacket end portion 44e. One or both of the seal surface 11e and drive surface 81e may be tapered to facilitate radial inward compression of the O-ring seal 76e when the seal nut 73e is tightened with the fitting nut 3e.

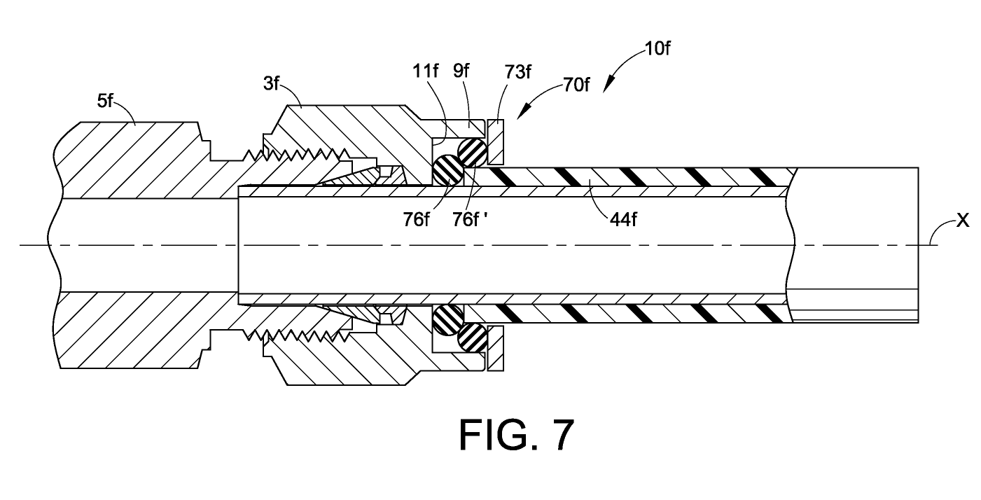

Other types of seal engaging members may be utilized to compress one or more sealing elements with the tubing jacket and with a sealing surface of the fitting nut. For example, FIG. 7 illustrates an exemplary fitting 10f that includes a spring washer 73f having an inner diameter sized for an interference fit with the tube jacketing 2f, such that the spring washer 73f can be pushed against an extension 9f of the fitting nut 3f to compress sealing elements 76f, 76f for sealing engagement between a seal surface 11f of the fitting nut 3f and the jacket end portion 44f. While the sealing elements 76f, 76f are shown as separate nut and jacket engaging O-rings, other sealing elements may instead be utilized, such as, for example, a gasket having an L-shaped cross-section, or a caulking or other such sealant material. While the fitting nut sealing surface may be provided in a variety of configurations, the illustrated sealing surface 11f is disposed in a socket in the fitting nut 3f, to facilitate containment of the sealing elements 76f, 76f.

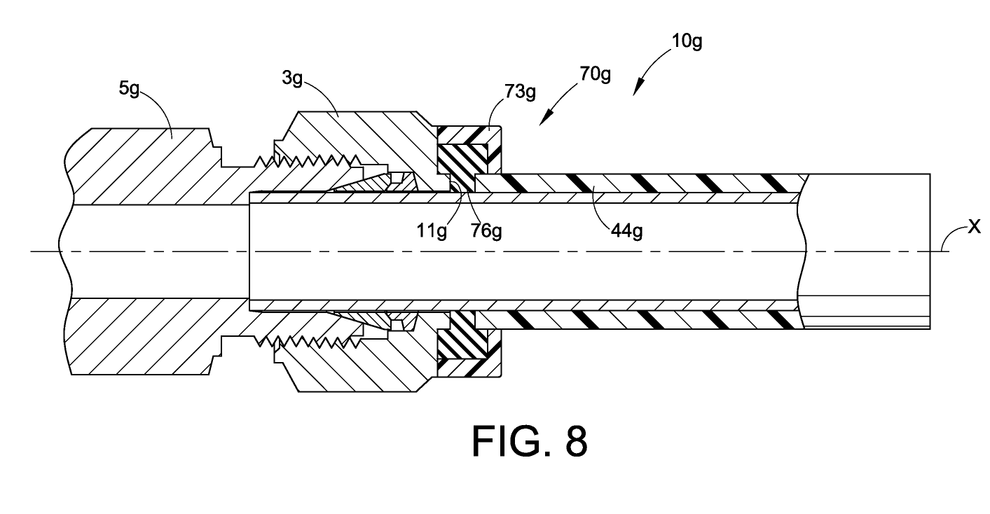

In still another embodiment, as shown in FIG. 8, a fitting 10g is provided with a hollow cap seal engaging member 73g having an inner diameter sized for an interference fit with the jacket end portion 44g, such that the hollow cap 73g can be pushed against the fitting nut 3g to compress sealing element 76g for sealing engagement between an end seal surface 11g of the fitting nut 3g and the jacket end portion 44g. The sealing element 76g may include any suitable gasket, sealant, or other such component sized to be received in the recessed portion of the hollow cap 73g. Where a sealant is used, excess sealant extruding between the hollow cap 73g and the fitting nut 3g may be wiped away after assembly.

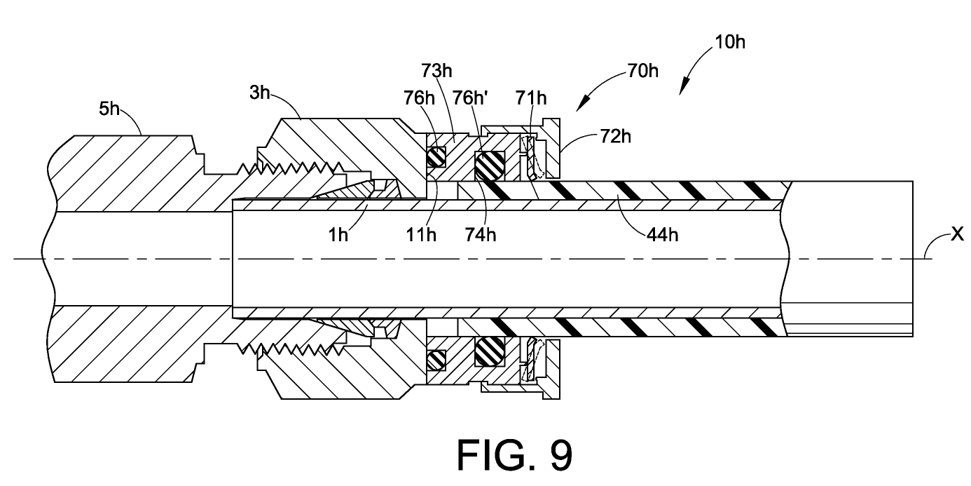

In another embodiment, a push-to-connect seal engaging member may be utilized to seal against an end portion of a tubing jacket and an end face of a fitting nut. FIG. 9 illustrates an exemplary fitting 10h provided with a push-to-connect seal engaging member 73h configured for self-locking engagement of a nut engaging O-ring 76h with an end face 11h of the fitting nut 3h. A jacket engaging O-ring 76h′ is disposed in an annular recess 74h in the seal engaging member 73h for sealing engagement with the jacket end portion 44h. When the tubing 1h is inserted through the seal engaging member 73h, a spring washer 71h retained within the seal engaging member 73h is flexed to grip the jacket end portion 44h in a nut engaging condition. To release the seal engaging member 73h, a button member 72h is depressed to deflect the spring washer 71h out of the jacket gripping condition to allow for retraction of the seal engaging member 73h.

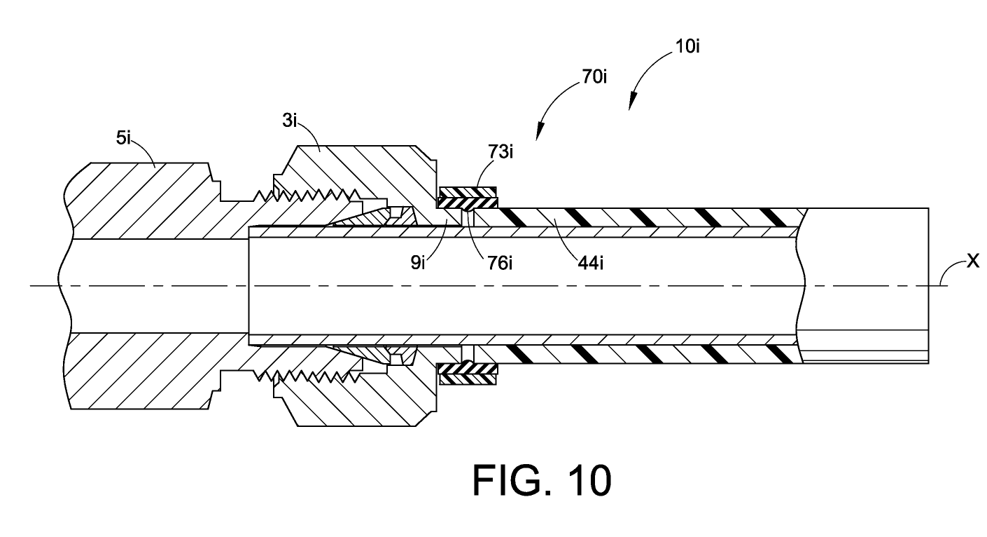

In yet another embodiment, a sealing sleeve may be secured (e.g., by a clamp or other seal engaging member) over a jacket end portion and a portion of the fitting nut to provide a moisture-tight seal over an exposed end of a jacketed tubing. FIG. 10 illustrates an exemplary fitting 10i provided with a jacket sealing device 70i including an elastomeric sleeve 76i for assembly with the fitting nut 3i. The fitting nut 3i includes a collar portion or extension 9i that receives the sleeve 76i in a press fit or interference fit engagement. The extension 9i may be sized to have an outer diameter consistent with or similar to an outer diameter of the jacket end portion 44i of the tubing 1i, such that an elastomeric sleeve 76i having a uniform inner diameter may effectively seal against both the nut extension 9i and jacket end portion 44i. As shown, the jacket sealing device 70i includes a clamp-type seal engaging member 73i (e.g., a tie, wrap, or hose clamp) secured to the outer diameter of the sleeve 76i to grip the sleeve 76i to maintain sealing engagement between the sleeve 76i and the jacket end portion 44i and fitting nut 3i.

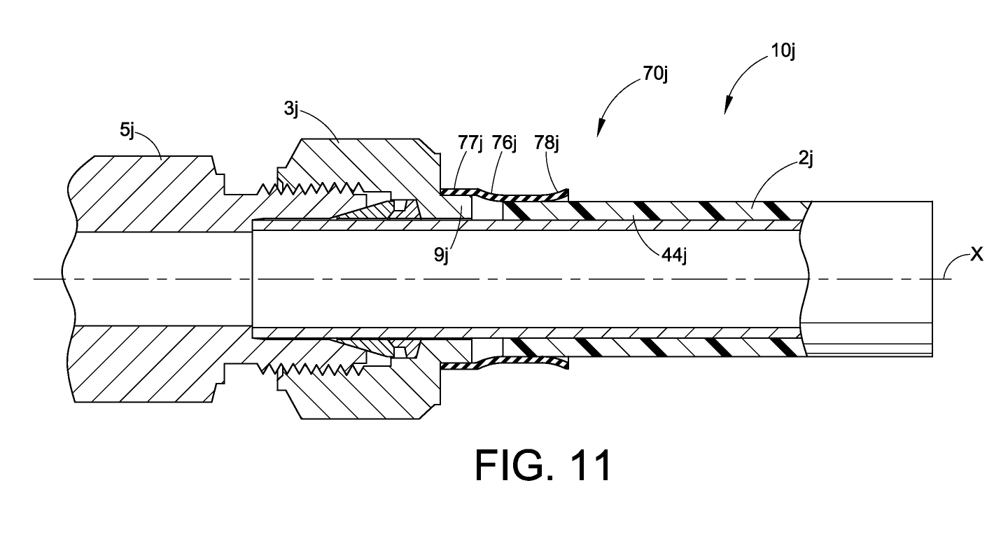

In other embodiments, a sealing element may be sized and configured to provide a sufficient interference fit or gripping engagement with a jacket end portion and fitting nut to effect an adequate seal without use of a separate seal engaging member (for example, the seal engaging member may be integral with the sealing element). For example, as shown in FIG. 11, a fitting 10j may include a molded elastomeric sleeve 76j sized to provide a sealing compression grip on the jacket end portion 44j and on the fitting nut extension 9j. The sealing element 76j may, for example, be a molded rubber sleeve (or one or more other suitable elastomeric materials). While the sleeve 76j may have a uniform inner diameter, in other embodiments, the sleeve may include a nut engaging end 77j having an inner diameter that is different in size and/or shape than an inner diameter of a jacket engaging end 78j, for example, to accommodate a nut having an outer diameter that is different from the outer diameter of the tubing jacket 2j (e.g., the outer hex surface of a standard fitting nut).

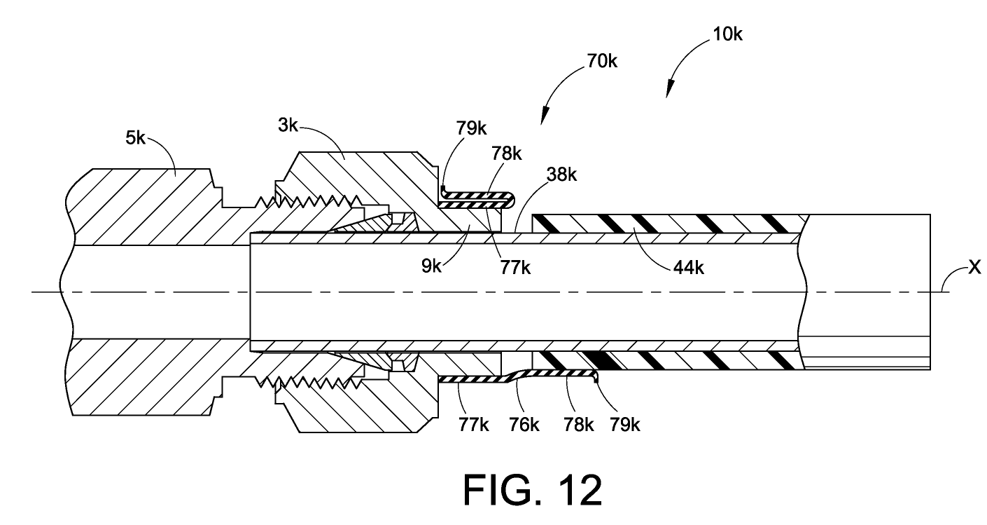

In another embodiment, as shown in FIG. 12, a fitting 10k may include an elastomeric sleeve 76k having a jacket engaging end 78k that is rolled up over a fitting engaging end 77k and retained on an extension 9k of a fitting nut 3k prior to installation of the fitting 10k. When the fitting is assembled with the exposed end 38k of the jacketed tubing 1k, the jacket engaging end 78k of the sleeve 76k may be unrolled for engagement with the jacket end portion 44k, as shown in the bottom half of the cross-sectional view of FIG. 12. As shown, the jacket engaging end 78k may be provided with a flange 79k or other such projection to facilitate grasping by the user during installation or disassembly of the fitting. The fitting 10k may additionally utilize a clamp-type seal engaging member around the sleeve 76k to facilitate sealing engagement, as shown in the embodiment of FIG. 10.

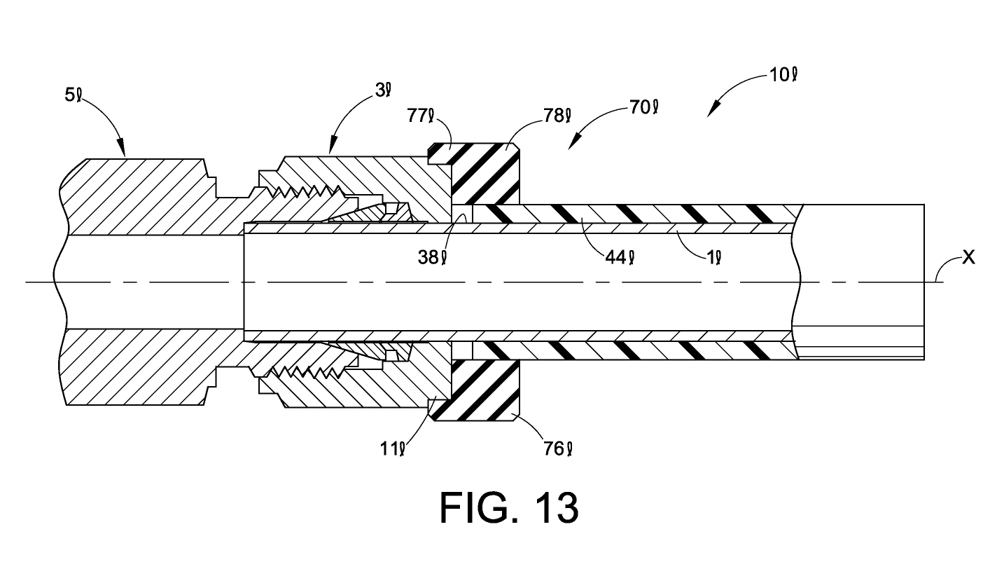

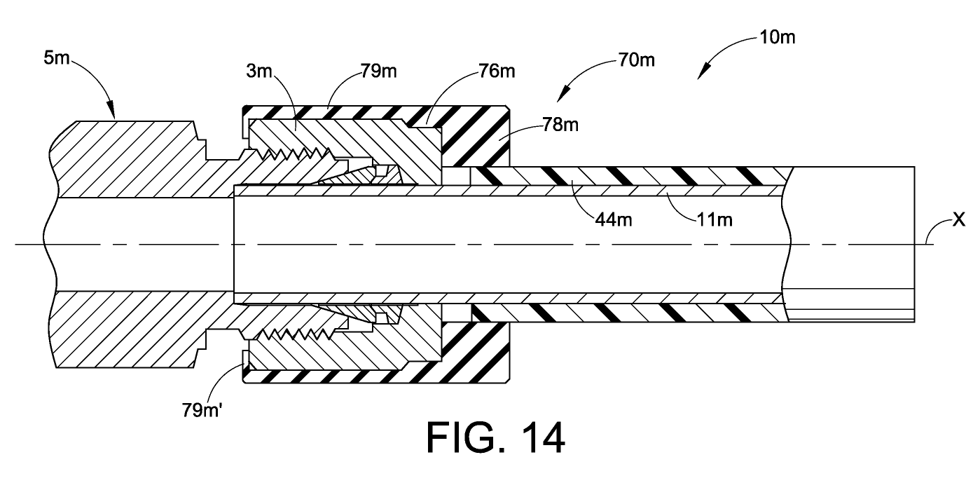

In still another embodiment, as shown in FIG. 13, a fitting 10l may include an elastomeric cover 76l having a jacket engaging end 78l with a first, smaller inner diameter that closely receives (e.g., with an interference fit) a jacket end portion 44l of the tubing 1l. A nut engaging end 77l of the cover 76l includes a socket with a second, larger inner diameter that closely receives (e.g., with an interference fit) an end portion 11l of the nut 3l. In yet another embodiment, as shown in FIG. 14, a nut engaging end 77m of a cover 76m may include a sleeve portion 79m (which may, but need not, be integral with the rest of the cover 76m) and inward lip 79m′ that extend over and around the nut hex to sealingly retain the cover 76m on the nut 3m.

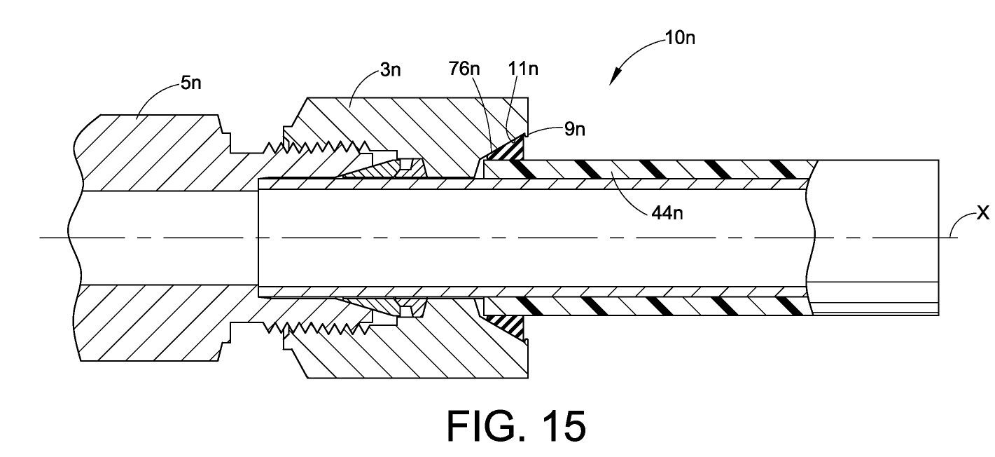

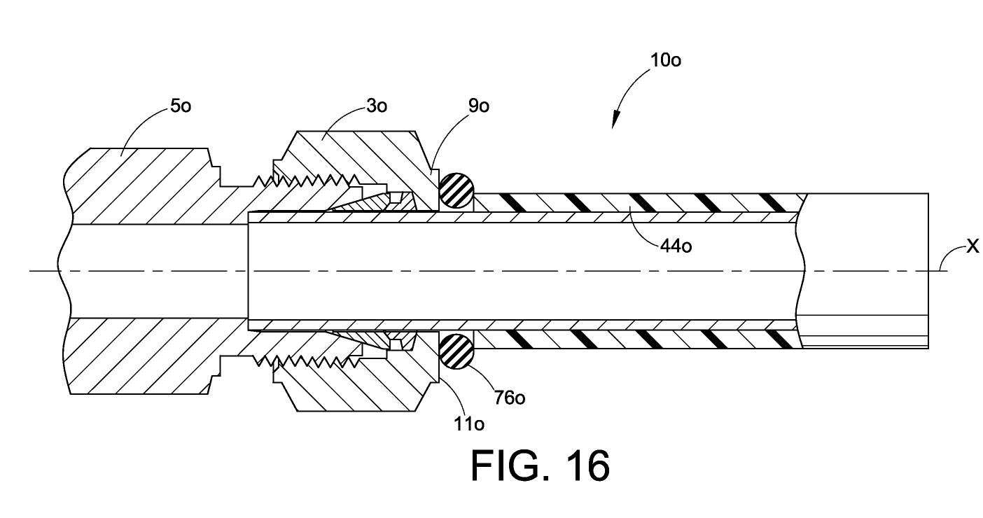

Other types of sealing elements may be provided to seal directly with a fitting nut. For example, as shown in FIG. 15, a fitting 10n may be provided with a fitting nut 3n having an internal chamfer or inner peripheral recess 11n into which an elastomeric grommet 76n may be wedged or pushed to provide sealing engagement between the nut 3n and the jacket end portion 44n. As shown, the fitting nut 3n may include an inwardly extending lip 9n or other projection to facilitate retention of the installed grommet 76n. In another embodiment, as shown in FIG. 16, an O-ring seal 76o may be wedged or axially squeezed or compressed between a jacket end portion 44o and an installed fitting nut 3o to provide a seal between the jacket end portion 44o and an end face 11o of the fitting nut 3o.

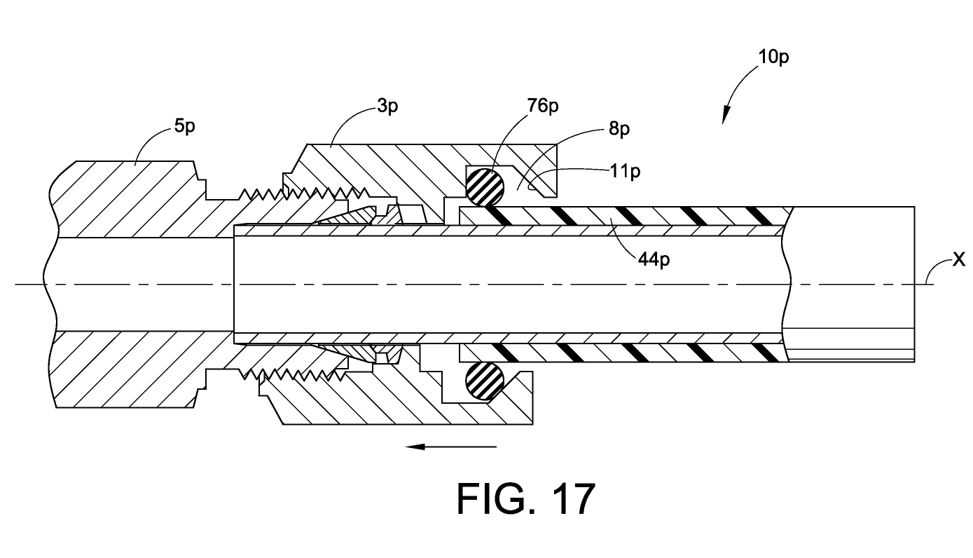

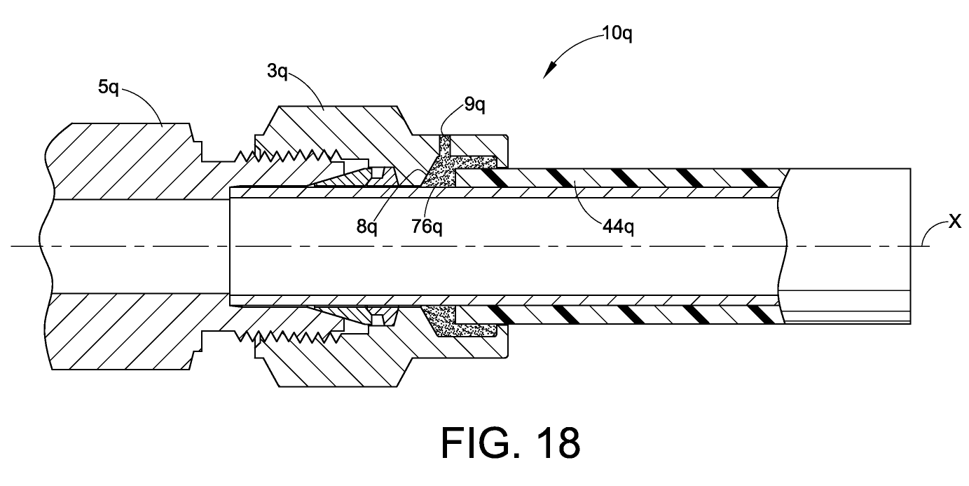

In other embodiments, a fitting nut may be providing with a sealing element retaining recess, with a retained sealing element providing a moisture-tight seal between the fitting nut and the tubing jacket. For example, as shown in FIG. 17, a fitting 10p may include a fitting nut 3p having an annular internal recess 8p for retaining an O-ring seal 76p or other such elastomeric sealing member. The recess 8p includes a tapered inward facing surface 11p. As shown in the bottom half of the cross-sectional view of FIG. 17, when the fitting nut 3p is tightened onto the fitting body 5p, the tapered surface 11p of the advancing nut 3p engages the O-ring seal 76p to compress the O-ring seal against the jacket end portion 44p, providing a moisture-tight seal between the fitting nut 3p and the jacket end portion 44p. As another example, as shown in FIG. 18, a fitting nut 3q may be provided with an internal recess 8q and an intersecting access port 9q. A sealant 76q, such as, for example, an expanding urethane foam, may be injected into the access port 9q to provide a moisture-tight seal between the fitting nut 3q and the jacket end portion 44q.

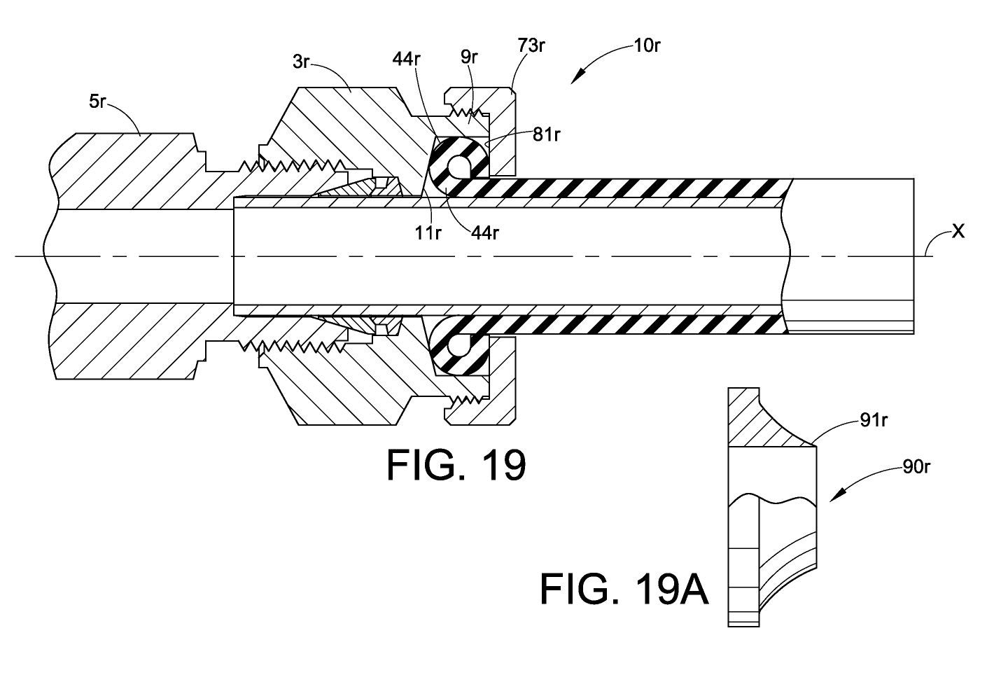

In additional embodiments of the present disclosure, the fitting nut and/or seal engaging member may be configured to seal directly with the tubing jacket. For example, an end portion of the jacket may be deformed or otherwise manipulated to function as a sealing element. In one such embodiment, an endmost portion of the jacket may be rolled up and axially compressed between the fitting nut and seal engaging member to effect a seal. FIG. 19 illustrates an exemplary fitting 10r that includes a second nut or seal nut 73r for assembly with a threaded extension 9r of the fitting nut 3r. Sealing surfaces 11r, 81r of the fitting nut 3r and seal nut 73r engage opposite sides of a rolled up end portion 44r of the jacket 2r, to provide a fluid-tight seal between the fitting nut 3r and the jacket 2r. While many different mechanisms may be utilized to prepare the rolled jacket end portion 44r for fitting assembly, FIG. 19A illustrates an exemplary collet or tool 90r having a sharp tapered nose portion 91r that may be pressed against the jacket end portion 44r to roll up the end portion.

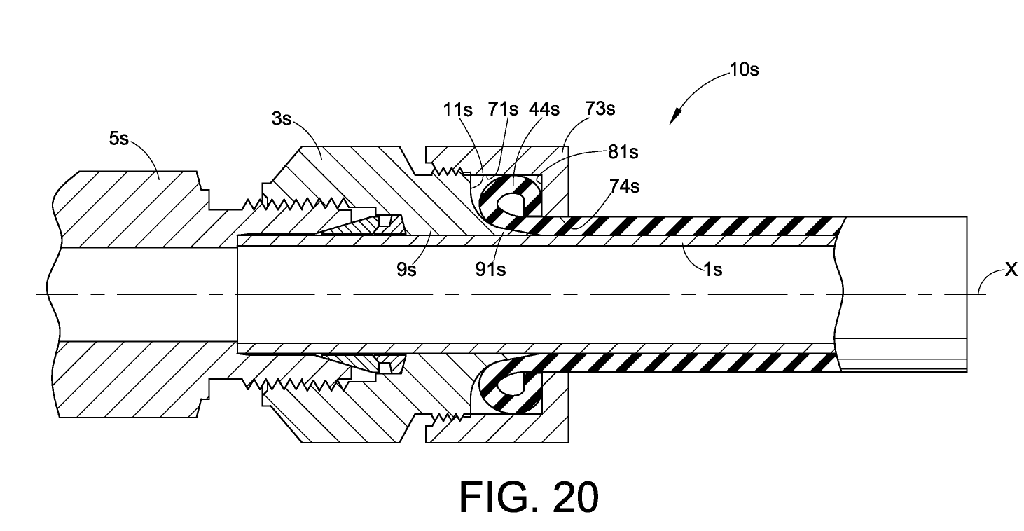

In another embodiment, an endmost portion of the jacket may be expanded and radially compressed between the fitting nut and seal engaging member to effect a seal. In the exemplary embodiment of FIG. 20, a fitting 10s includes a fitting nut 3s having a threaded extension 9s with a wedge shaped nose portion 91s configured to expand the jacket end portion 44s when the tubing is inserted into the fitting nut 3s. A seal engaging member or seal nut 73s is assembled with the threaded portion 9s of the fitting nut for radial compression of the expanded jacket end portion 44s between the fitting nut nose portion 91s and an inner surface 71s or 74s of the seal nut 73s. Additionally or alternatively, a rolled jacket end portion 44s may be axially compressed between radially extending sealing surfaces 11s, 81s of the fitting nut 3s and seal nut 73s to effect a seal.

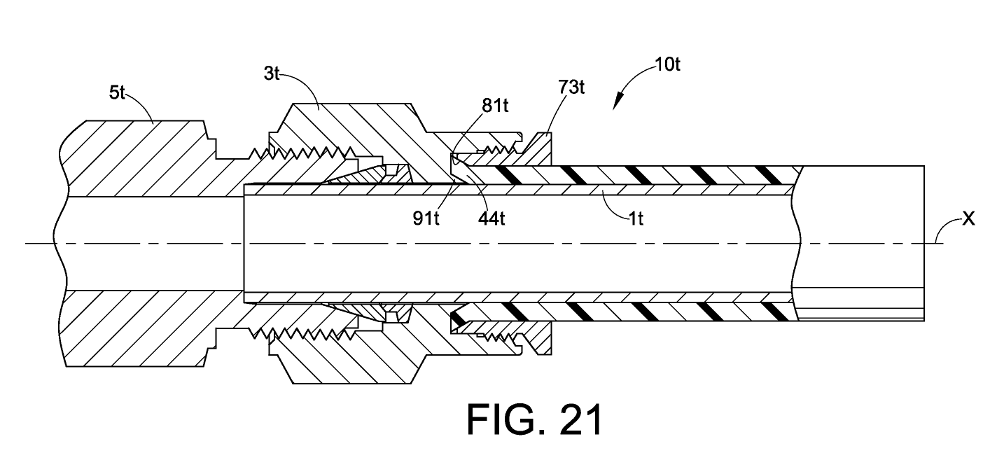

In another embodiment, as shown in FIG. 21, a fitting 10t includes a fitting nut 3t having a female threaded extension 9t with an internal annular wedge portion 91t positioned to expand the jacket end portion 44t from the tubing 1t when the tubing is inserted into the fitting nut 3t. A male threaded seal engaging member or seal nut 73t may then be threaded into the female threaded extension 9t to compress the jacket end portion 44t between a sealing surface 81t of the seal nut 73t and the wedge portion 91t of the fitting nut 3t.

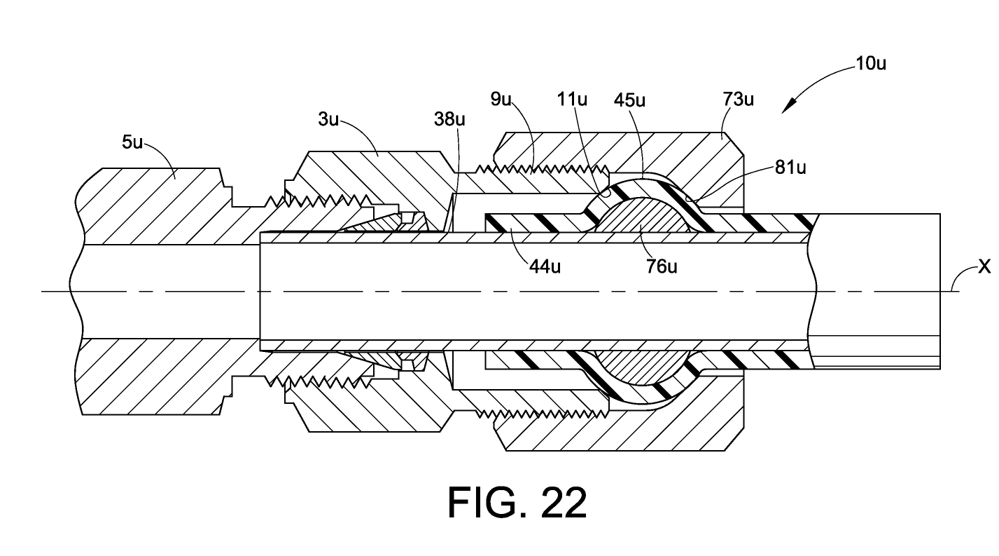

In yet another embodiment, as shown in FIG. 22, a fitting 10u includes an olive 76u or other such gland that is slid over the exposed tube end 38u and under the jacket end portion 44u to create a bulge 45u in the jacketed end portion 44u. The bulge 45u may then be axially or axially and radially compressed between sealing surfaces 11u, 81u of the fitting nut 3u and the seal engaging member or seal nut 73u to provide a seal between the fitting 10u and the jacket end portion 44u.

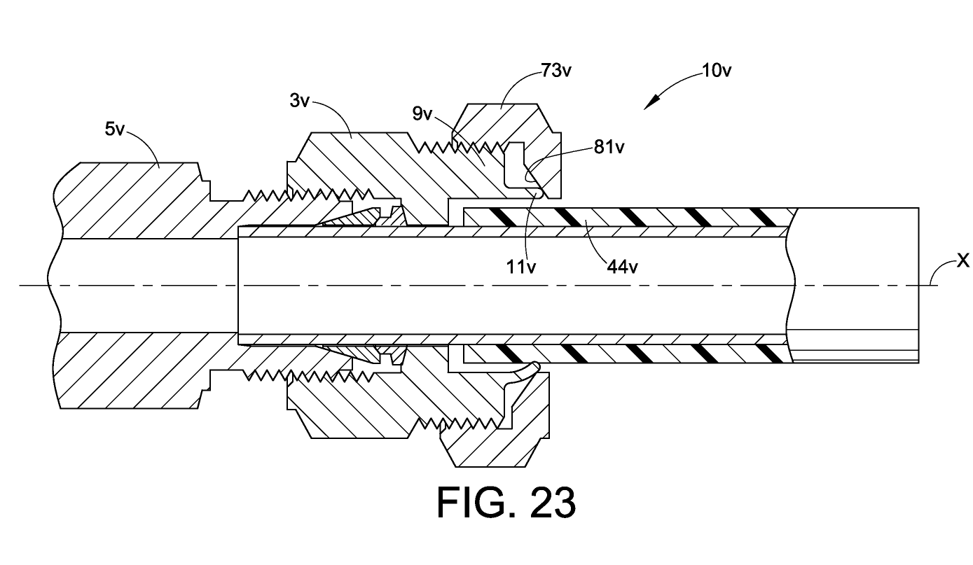

In other embodiments, a fitting nut may be provided with a jacket sealing structure configured to grip and seal against the tubing jacket when the fitting is installed on the tubing. In one such embodiment, a seal engaging member is assembled with the fitting nut to radially compress the jacket sealing structure of the fitting nut into sealing engagement with the tubing jacket. For example, as shown in FIG. 23, a fitting 10v may include a fitting nut 3v with a threaded extension 9v having an axially extending sealing tab or collar 11v configured for assembly with a second nut or seal nut 73v. The seal nut 73v includes a tapered drive surface 81v that engages the sealing collar 11v to radially compress the sealing collar 11v into sealing engagement with the jacket end portion 44v, as shown in the bottom half of the cross-sectional view of FIG. 23.

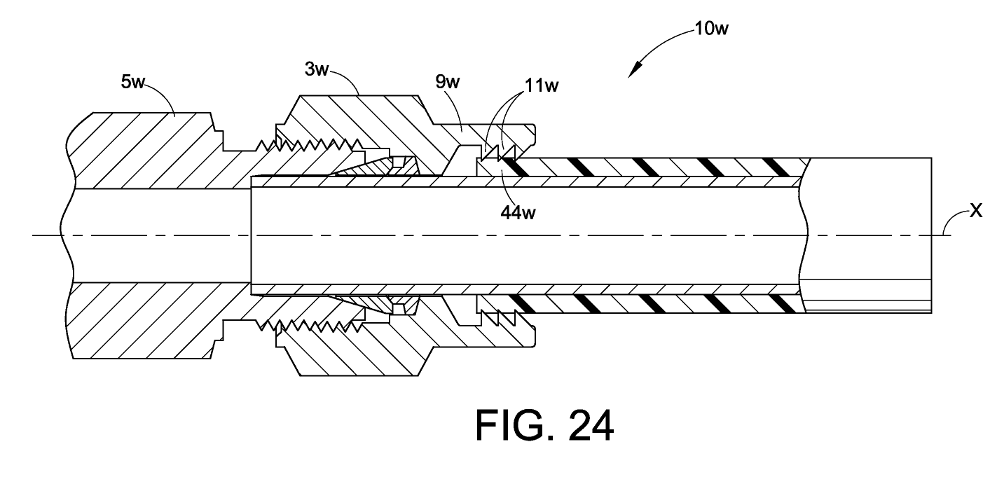

In another embodiment, a fitting nut is provided with a radially inwardly biased collar that is configured to seal against the tubing jacket upon installation of the fitting with the tubing, without the assembly of a separate seal engaging member. In the exemplary embodiment of FIG. 24, a fitting 10w includes a fitting nut 3w with a collar shaped extension 9w having one or more ribs 11w extending radially inward for biased sealing engagement with the jacket end portion 44w, inwardly deforming the jacket end portion to effect a seal. While the ribs may be provided in any suitable shape, the illustrated ribs 11w are barbed in cross-section to facilitate gripping engagement with the jacket end portion 44w.

According to another aspect of the present disclosure, a fitting may be further configured to provide a fluid-tight or moisture-tight seal between the body and nut threads of the fitting assembly, thus further protecting an unjacketed portion of a tube end from external moisture or other contaminants. In one embodiment, a thread sealant may be provided between the fitting body and nut threads to effect a moisture-tight seal. Any suitable thread sealant may be utilized, including, for example, PTFE-free sealants, such as Swagelok PTFE-Free sealant.

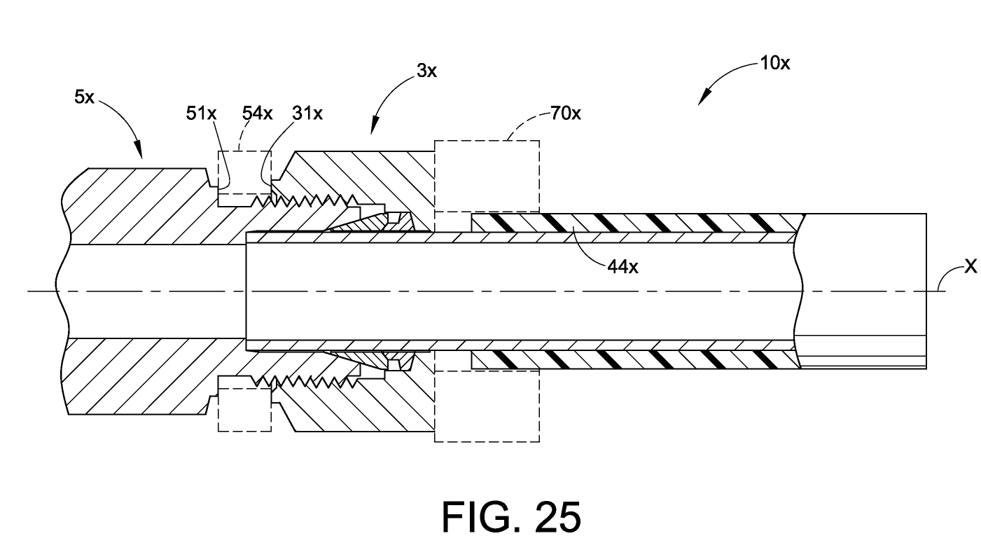

In another embodiment, a seal may be provided between opposed surfaces of a fitting body and fitting nut, such that when the nut is pulled up on the body, the seal is compressed between the opposed surfaces to effect a seal around the fitting threads. In the exemplary embodiment of FIG. 25, a fitting 10x is provided with a mechanical connection seal member, shown schematically at 54x, disposed between opposed fitting body and nut surfaces 51x, 31x and sized for sealing engagement with the fitting body and nut around the threaded connection when the fitting nut 3x is pulled up on the body 5x. This mechanical connection seal member 54x may be provided in combination with a jacket sealing device 70x(for example, any of the exemplary jacket sealing devices described herein) to provide a moisture-tight seal along the entire length of the fitting 10x.

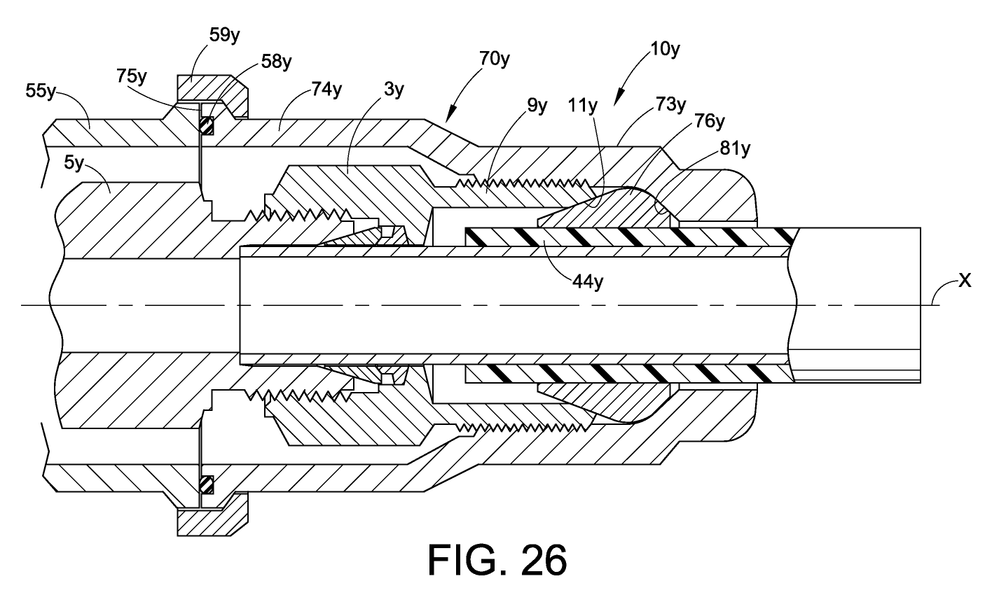

In still another embodiment, a jacket sealing device may be configured to fully surround the assembled fitting connection of a fitting body, fitting nut, and tube end, thereby providing a moisture-tight seal over both the body-nut connection and the space between the nut and the end of the tubing jacket. In the exemplary embodiment of FIG. 26, a fitting 10y is provided with a jacket sealing device 70y including a seal engaging member 73y for assembly with the fitting nut 3y, and a sealing element 76y captured in a cavity 48y defined between the jacket portion 44y and an interior wall of the seal engaging member 73y. The fitting nut 3y and sealing element 76y may, but need not, be similar to the fitting nut 3a and sealing element 76a of the embodiment of FIG. 2. The exemplary seal engaging member 73y is formed as a fitting encapsulating cover, having a bell-shaped end portion 74y that surrounds the fitting nut 3y. The end portion 74y includes a sealing end face 75y that mates with a corresponding body encapsulating member 55y (using, for example, an O-ring seal 58y and a threaded clamping ring 59y), which may be integral with, assembled to, or assembled around the fitting body 5y, such that the jacket sealing device 70y provides a moisture-tight seal around the entire fitting connection.

The inventive aspects have been described with reference to the exemplary embodiments. Modification and alterations will occur to others upon a reading and understanding of this specification. It is intended to include all such modifications and alterations insofar as they come within the scope of the appended claims or the equivalents thereof.

1. A conduit fitting, comprising:
first and second fitting components that can be joined, and at least one conduit gripping device that can grip and seal against an unjacketed portion of a metal conduit when the first and second fitting components are pulled up on the metal conduit;
a sealing element; and
a seal engaging member that can be joined with at least one of the metal conduit, the first fitting component, and the second fitting component to compress the sealing element against a jacketed portion of the metal conduit.

2. The fitting of claim 1, wherein the first fitting component is a fitting body and the second fitting component is a fitting nut.

3. The fitting of claim 1, wherein the sealing element forms a fluid-tight seal against an outer surface of the jacketed portion of the metal conduit when the first and second fitting components are pulled up on the metal conduit and the seal engaging member is joined with the at least one of the metal conduit, the first fitting component, and the second fitting component.

3. The fitting of claim 1, wherein the seal engaging member comprises a seal nut configured to threadably engage a threaded extension on the second fitting component.

4. The fitting of claim 1, wherein the seal engaging member comprises a clamping member configured to radially compress the sealing element.

5. The fitting of claim 1, wherein the sealing element comprises a compressible polymer.

6. The fitting of claim 1, wherein the sealing element is axially compressible between the seal engaging member and the second fitting component.

7. The fitting of claim 1, wherein the sealing element is radially compressible between the seal engaging member and the second fitting component.

8. The fitting of claim 1, wherein the sealing element comprises an O-ring.

9. The fitting of claim 1, wherein the sealing element comprises an axially tapered surface that engages a sealing surface on the second fitting component when the seal engaging member is joined with the at least one of the metal conduit and the first and second fitting components.

10. The fitting of claim 1, wherein the sealing element comprises an axially tapered surface that engages a drive surface on the seal engaging member when the seal engaging member is joined with the at least one of the metal conduit and the first and second fitting components.

11. The fitting of claim 1, wherein the sealing element is configured to seal against an internal surface of the second fitting component.

12. The fitting of claim 1, wherein the sealing element is configured to seal against an external surface of the second fitting component.

13. The fitting of claim 1, wherein the sealing element is integral with the second fitting component.

14. The fitting of claim 1, wherein the sealing element is integral with the seal engaging member.

15. The fitting of claim 1, further comprising a mechanical connection seal member disposed between opposed surfaces of the first and second fitting components to provide a fluid tight seal around a connection between the first and second fitting components when the first and second fitting component are pulled up on the metal conduit.

16. A fitting assembly comprising:
a metal conduit comprising a jacketed portion having a protective jacket surrounding an outer surface of the metal conduit, and an unjacketed portion at a first end of the metal conduit;
a fitting body;
at least one conduit gripping device;
a sealing element; and
a fitting nut including:
a body engaging end portion configured to be joined with the fitting body to define a cavity for retaining the at least one conduit gripping device therein, and a radially extending drive surface configured to engage the at least one conduit gripping device to provide a grip and seal with an unjacketed portion of the metal conduit; and
a seal engaging end portion opposite the body engaging end portion, the seal engaging end portion including a sealing surface configured to engage the sealing element, wherein the sealing element provides a fluid-tight seal between the fitting nut and the jacketed portion of the metal conduit.

17. The fitting assembly of claim 16 wherein the protective jacket comprises at least one of PVC and TPU.

18. The fitting assembly of claim 16 wherein the sealing element comprises at least one of an elastomer and a polymer.

19. The fitting assembly of claim 16, wherein the sealing element comprises a modified portion of the protective jacket.

20-30. (canceled)

31. A fitting nut for installation with a fitting body on a jacketed conduit, the fitting nut comprising:
a body engaging end portion configured to be joined with the fitting body to define a cavity for retaining at least one conduit gripping device therein, and a radially extending drive surface configured to engage the at least one conduit gripping device to provide a grip and seal with an unjacketed portion of the jacketed conduit; and
a seal engaging end portion opposite the body engaging end portion, the seal engaging end portion including a threaded extension configured to be joined with a seal engaging member to define a cavity for retaining at least one sealing element therein, and a sealing surface configured to engage the at least one sealing element to provide sealing engagement with a jacketed portion of the jacketed conduit.
